(19) United States
(12) Patent Application Publication
(10) Pub. No.: US 2024/0179241 A1
(43) Pub. Date: May 30, 2024

(54) SYSTEM AND METHOD FOR FRAUD AND ABUSE DETECTION

(71) Applicant: MGKGSC, LLC, Scottsdale, AZ (US)

(72) Inventors: Michael G. Kucera, Scottsdale, AZ (US); Dan Casson, Scottsdale, AZ (US)

(21) Appl. No.: 18/524,813

(22) Filed: Nov. 30, 2023

Related U.S. Application Data
(60) Provisional application No. 63/428,988, filed on Nov. 30, 2022.

(51) Int. Cl. H04M 3/436; G06F 40/30

(52) U.S. Cl. CPC H04M 3/436; G06F 40/30; H04M 2203/6027

(57) ABSTRACT

A fraud and abuse detection method includes analyzing an incoming call in near real-time using a sentiment analysis module, where the sentiment analysis module includes one or more sentiment analysis models configured to analyze a sentiment of a callee's voice. The method includes generating a confidence risk score in near real-time based on the sentiment analysis of the incoming call, where the confidence risk score corresponds to a likelihood of fraud or abuse based on the sentimental analysis data from the sentiment analysis module. The method includes performing one or more actions using a circuit breaker module based on a determined risk score, where the one or more actions include one or more risk threshold tier actions corresponding to a respective confidence risk score.

### CROSS-REFERENCE TO RELATED APPLICATIONS

The present application claims the benefit under 35 U.S.C. § 119(e) of U.S. Provisional Application Ser. No. 63/428,988, filed Nov. 30, 2022, entitled FRAUD DETECTION SYSTEM AND METHOD, naming Michael G. Kucera and Dan Casson as inventors, which is incorporated herein by reference in the entirety.

### TECHNICAL FIELD

The present invention generally relates to fraud and abuse prevention, and, more particularly, to a system and method for fraud and abuse detection.

### BACKGROUND

Fraudsters often target the vulnerable population (e.g., elderly, young people, disabled people, and the like) using phone-based fraud schemes. In particular, the phone-based fraud schemes allow the fraudsters to easily misrepresent or conceal their true identities in order to obtain personal information (e.g., personal identity information (PII), personal health information (PHI), and the like), financial information, and the like. As such, it is desirable to provide a fraud detection system and method.

### SUMMARY

A fraud and abuse detection system is disclosed, in accordance with one or more embodiments of the present disclosure. In embodiments, the system includes one or more platform servers communicatively coupled to a caller device, a callee device, and a caregiver device. In embodiments, the one or more platform servers include one or more processors configured to execute a set of program instructions stored in a memory. In embodiments, the one or more platform servers include a sentiment analysis module stored in memory and a circuit breaker module stored in memory. In embodiments, the set of program instructions are configured to cause the one or more processors to analyze an incoming call in near real-time using the sentiment analysis module, where the sentiment analysis module includes one or more sentiment analysis models configured to analyze a sentiment of a callee's voice. In embodiments, the set of program instructions are configured to cause the one or more processors to generate a confidence risk score in near real-time based on the sentiment analysis of the incoming call, where the confidence risk score corresponds to a likelihood of fraud or abuse based on the sentimental analysis data from the sentiment analysis module. In embodiments, the set of program instructions are configured to cause the one or more processors to perform one or more actions using the circuit breaker module based on the generated risk score, where the one or more actions include one or more risk threshold tier actions corresponding to a respective confidence risk score.

A fraud and abuse detection system is disclosed, in accordance with one or more embodiments of the present disclosure. In embodiments, the system includes one or more user devices, where the one or more user devices include at least a callee device. In embodiments, the system includes one or more platform servers communicatively coupled to a caller device, a callee device, and a caregiver device. In embodiments, the one or more platform servers include one or more processors configured to execute a set of program instructions stored in a memory. In embodiments, the one or more platform servers include a sentiment analysis module stored in memory and a circuit breaker module stored in memory. In embodiments, the set of program instructions are configured to cause the one or more processors to analyze an incoming call in near real-time using the sentiment analysis module, where the sentiment analysis module includes one or more sentiment analysis models configured to analyze a sentiment of a callee's voice. In embodiments, the set of program instructions are configured to cause the one or more processors to generate a confidence risk score in near real-time based on the sentiment analysis of the incoming call, where the confidence risk score corresponds to a likelihood of fraud or abuse based on the sentimental analysis data from the sentiment analysis module. In embodiments, the set of program instructions are configured to cause the one or more processors to perform one or more actions using the circuit breaker module based on the generated confidence risk score, where the one or more actions include one or more risk threshold tier actions corresponding to a respective confidence risk score.

A fraud and abuse detection method is disclosed, in accordance with one or more embodiments of the present disclosure. In embodiments, the method includes analyzing an incoming call in near real-time using a sentiment analysis module, where the sentiment analysis module includes one or more sentiment analysis models configured to analyze a sentiment of a callee's voice. In embodiments, the method includes generating a confidence risk score in near real-time based on the sentiment analysis of the incoming call, where the confidence risk score corresponds to a likelihood of fraud or abuse based on the sentimental analysis data from the sentiment analysis module. In embodiments, the method includes performing one or more actions using a circuit breaker module based on a determined risk score, where the one or more actions include one or more risk threshold tier actions corresponding to a respective confidence risk score.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the disclosure may be better understood by those skilled in the art by reference to the accompanying figures in which:

FIG. 1A is a simplified block diagram of a fraud detection system, in accordance with one or more embodiments of the present disclosure.

FIG. 1B is a simplified schematic diagram of the fraud detection system, in accordance with one or more embodiments of the present disclosure.

FIG. 2 is a call transcript log, in accordance with one or more embodiments of the present disclosure.

FIG. 3A is a sentiment analysis plot, in accordance with one or more embodiments of the present disclosure.

FIG. 3B is a sentiment analysis score, in accordance with one or more embodiments of the present disclosure.

FIG. 4A is a graphical user interface including real-time call analytics, in accordance with one or more embodiments of the present disclosure.

FIG. 4B is a graphical user interface including real-time call analytics, in accordance with one or more embodiments of the present disclosure.

FIG. 5 is a simplified flow diagram depicting a method for fraud and abuse detection using the fraud and abuse detection system, in accordance with one or more embodiments of the present disclosure.

FIG. 6 is a process flow diagram depicting a method for performing an initial screening using the fraud and abuse detection system, in accordance with one or more embodiments of the present disclosure.

FIG. 7 is process flow diagram depicting a method for performing fraud and abuse detection using the fraud and abuse detection system, in accordance with one or more embodiments of the present disclosure.

FIG. 8A is a graphical user interface depicting a real-time analysis of a call using the fraud and abuse detection system, in accordance with one or more embodiments of the present disclosure.

FIG. 8B is a graphical user interface depicting a real-time analysis of a call using the fraud and abuse detection system, in accordance with one or more embodiments of the present disclosure.

FIG. 8C is a graphical user interface depicting a real-time analysis of a call using the fraud and abuse detection system, in accordance with one or more embodiments of the present disclosure.

FIG. 9A is a graphical user interface depicting a real-time analysis of a call using the fraud and abuse detection system, in accordance with one or more embodiments of the present disclosure.

FIG. 9B is a graphical user interface depicting a real-time analysis of a call using the fraud and abuse detection system, in accordance with one or more embodiments of the present disclosure.

FIG. 9C is a graphical user interface depicting a real-time analysis of a call using the fraud and abuse detection system, in accordance with one or more embodiments of the present disclosure.

### DETAILED DESCRIPTION

The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Reference will now be made in detail to the subject matter disclosed, which is illustrated in the accompanying drawings.

Embodiments of the present disclosure are directed to a system and method for fraud and abuse detection. In particular, embodiments of the present disclosure are directed to a phone-based fraud detection system and method configured to identify potential fraud and abuse and prevent (or attempt to prevent) such fraud and abuse from occurring.

For example, the fraud and abuse detection system may include a fraud detection platform server configured to analyze calls in near real-time to identify potential fraud and/or abuse. For instance, the fraud detection platform server may be configured to detect requests for personal identification information (PII), personal health information (PHI), the callee's social security number (SSN), financial information, and the like, as well as threatening or inappropriate language. If the risk of fraud/abuse is too high, the call may be interrupted (by generating an interruption signal using a circuit breaker module) and the caller may be routed to a screening module. In this regard, the screen module may obtain additional information and provide such information to a caregiver, such that the caregiver can review the additional information to determine one or more future actions (e.g., disconnect the call, allow the call, send to voicemail, allow a one-time interaction, add to blacklist, add to allowed list, and the like).

By way of another example, the fraud and abuse detection system may be configured to perform an initial screening on the incoming call. If the caller passes the initial screening, the call may be routed to an intelligent screener (e.g., artificial intelligence agent, or the like) to gather additional information. Then, the fraud and abuse detection system may be configured to analyze the gathered information (e.g., check the caller ID, caller name, caller affiliation (e.g., company, organization, or the like), the content of the message, purpose of the call, and the like) and provide the analyzed data to a caregiver (or callee). The caregiver (or callee) may then decide whether to add the caller to the approved callers list or take one or more additional actions (e.g., allow a one-time interaction, blacklist, disconnect the call, or the like).

As such, the system and method for fraud and abuse detection may provide a powerful and easy to use tool for caregivers to manage and maintain approved callers to those in their care (e.g., elderly parents/relatives, young children, disabled individuals, and the like).

For purposes of the present disclosure, the term “callee” or variations thereof (e.g., “user”, “receiver”, “target”, “loved-one”, or the like) as used herein refers to a target of a phone scam.

For purposes of the present disclosure, the term “caller” or variations thereof (e.g., “scammer”, “perpetrator”, “adversary”, and the like) as used herein may refer to a perpetrator of a phone scam.

For purposes of the present disclosure, the term “guardian” or variations thereof (e.g., “caregiver”, “parent”, or the like) as used herein may refer to an individual (person or entity) who is providing oversight over the callee's device.

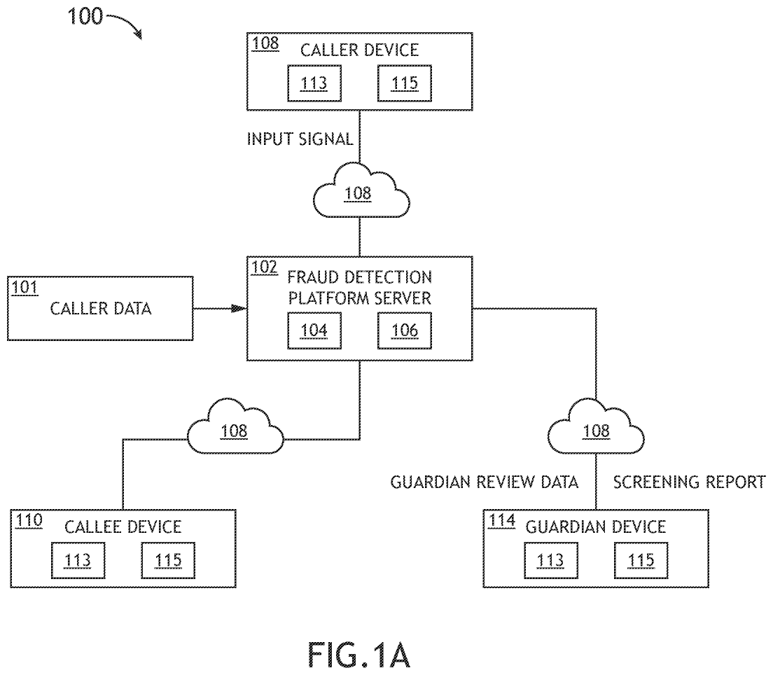

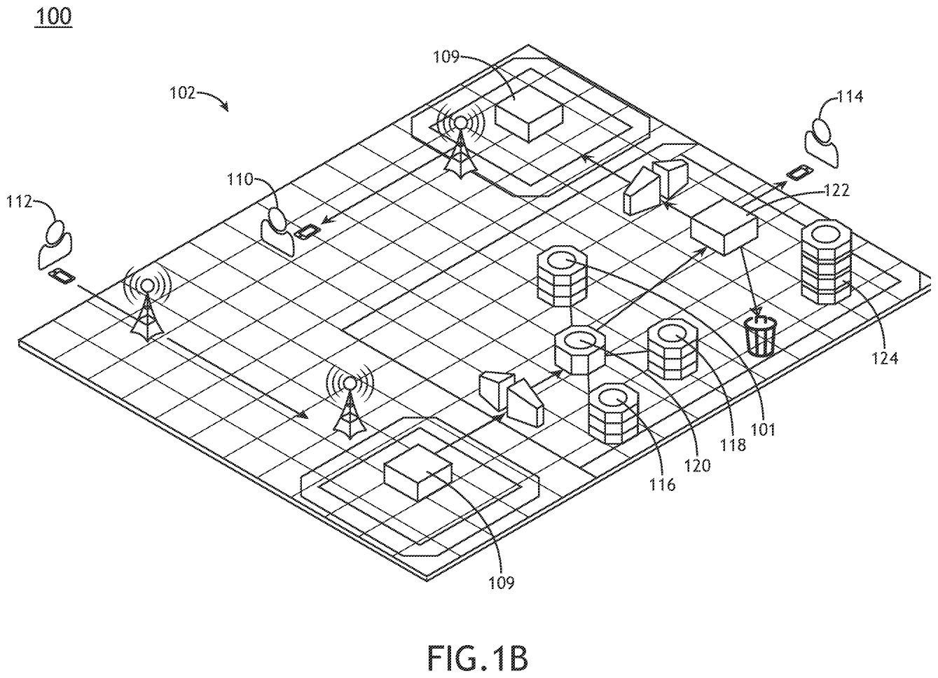

FIGS. 1A-1B illustrate a fraud detection system 100, in accordance with one or more embodiments of the present disclosure. In particular, FIG. 1A depicts a simplified block diagram of the fraud detection system 100, in accordance with one or more embodiments of the present disclosure. FIG. 1B depicts a simplified schematic diagram of the fraud detection system 100, in accordance with one or more embodiments of the present disclosure.

In embodiments, the fraud detection system 100 includes one or more fraud and abuse detection platform severs 102. For purposes of the present disclosure, the terms “fraud detection and abuse platform server”, “fraud and abuse detection platform”, “platform”, “server”, and variations thereof may be considered equivalent, unless otherwise noted herein. Further, although embodiments of the present disclosure focus on phone call-based fraud/abuse detection (or audio-based fraud/abuse detection), it is noted herein that embodiments of the present disclosure may be directed to text-based fraud/abuse detection.

The one or more platform servers 102 may include one or more processors 104 configured to execute program instructions maintained on a memory medium 106. In this regard, the one or more processors 104 of the one or more platform servers 102 may execute any of the various process steps described throughout the present disclosure. For example, the one or more processors 104 may be configured to detect fraud and abuse, as discussed further herein.

In embodiments, the one or more platform servers 102 may be hosted in a third-party data center of a network carrier. For example, the fraud detection platform 102 may be hosted on an on-premises third party data center of a network carrier.

In embodiments, the one or more platform servers 102 may be installed using a third-party cloud provider. For example, the one or more platform servers 102 may be installed and operated internally using a third-party cloud provider (e.g., Amazon Web Services®, or the like).

It is noted that the network carrier may include any network provider known in the art including, but not limited to, Verizon Wireless®, Sprint®, T-Mobile®, and the like.

In embodiments, the one or more platform servers 102 may be communicatively coupled to one or more user devices via the network 108. For example, the one or more platform servers 102 may be communicatively coupled to a callee user device 110 via the network 108. By way of another example, the one or more platform servers 102 may be communicatively coupled to a caller user device 112 via the network 108. By way of another example, the one or more platform servers 102 may be communicatively coupled to a guardian user device 114 via the network 108. In this regard, the one or more platform servers 102 and/or the one or more user devices (e.g., callee device 110, caller device 112, guardian device 114, and the like) may include a network interface device and/or the communication circuitry suitable for interfacing with the network 108.

For example, the callee device 110 may include a carrier bridge 109 to communicatively coupled the callee device 110 to the one or more platform servers 102 via the network 108. By way of another example, the caller device 112 may include a carrier bridge 109 to communicatively couple the caller device 112 to the one or more platform servers 102 via the network 108. The carrier bridge may include a third party network device (e.g., network carrier built-in equipment) configured to route the call data (e.g., voice or text data) from the carrier's network to the one or more platform servers 102 in a digital format. In this regard, the contents of the call data (e.g., real-time voice data, real-time text data, and the like) may be examined by the one or more platform servers 102 in near real-time and acted upon, as discussed further herein.

The one or more platform servers 102 may be configured to receive caller data 101. The caller data 101 may include, but is not limited to, a transcription of the call, a recording of the call, metadata of the call (e.g., caller profile data, location data, and the like), or the like.

For example, the one or more platform servers 102 may be configured to receive caller data 101 from a third-party application programming interface (API). For instance, the third-party API may be configured to receive caller data from a third-party provider. By way of another example, the one or more platform servers 102 may be configured to receive caller data 101 from a database. In one instance, the one or more platform servers 102 may be configured to receive caller data 101 from a remote database. In another instance, the one or more platform servers 102 may be configured to receive caller data 101 from a database stored in memory 106 of the one or more platform servers 102.

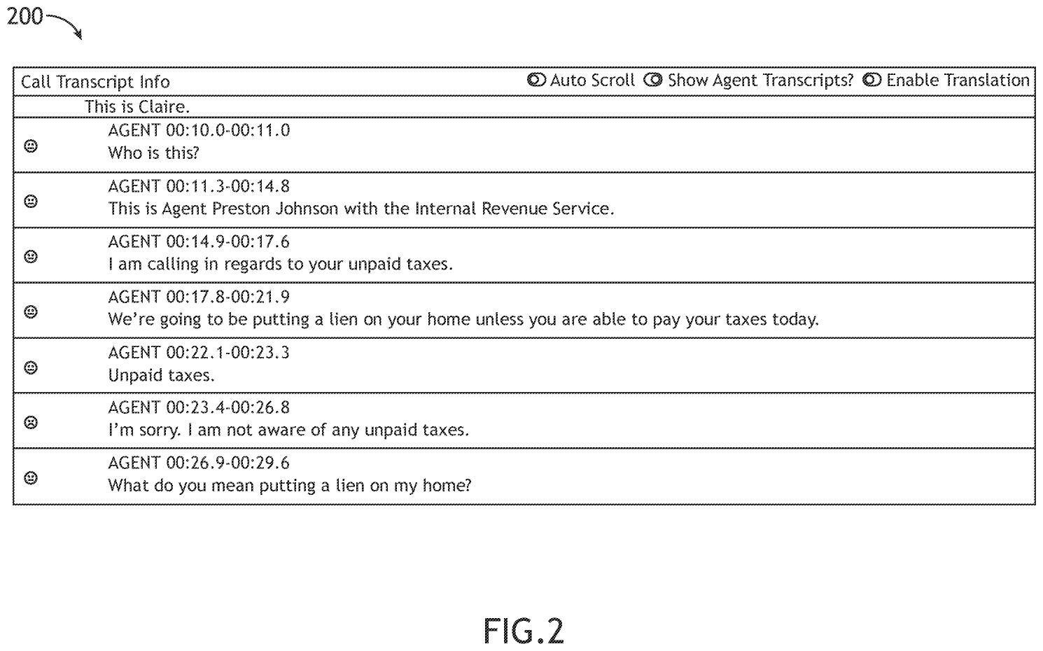

FIG. 2 illustrates a call transcription log 200, in accordance with one or more embodiments of the present disclosure.

In embodiments, the third-party provider may be configured to transcribe the audio in real-time and provide the transcription data to the one or more platform servers 102. For example, as shown in FIG. 2, the call transcription log 200 may include a near real-time transcription of the audio during the call. In embodiments, one or more fraud/abuse triggers may be identified based on the call transcription log 200. In a non-limiting example, as shown in FIG. 2, the one or more platform servers 102 may identify a request for financial information (or payment) based on the call transcription log 200.

In embodiments, the third-party provider may be configured to transcribe the audio after the call has commenced. For example, the third-party provider may be configured to transcribe the audio for a single provider and provide the transcription data to the one or more platform servers 102. By way of another example, the third-party provide may be configured to transcribe a plurality of audio recordings in batch and provide the batch of transcription data to the one or more platform servers 102.

In embodiments, the one or more platform servers 102 may include one or more one or more fraud and abuse modules. For example, the one or more platform servers 102 may include one or more machine learning/artificial intelligence modules. Each module may be configured to perform a distinct function. In this regard, the one or more platform servers 102 may be customizable based on the caregiver and/or loved one, network carrier constraints, and the like. Further, the one or more platform servers 102 may be easily maintained, updated, and monitored.

In embodiments, the one or more platform servers 102 include a caller database 116 stored in memory. For example, the database 116 may include a whitelist/blacklist database 116 including a database of “allowed” callers and/or “blocked” callers. For instance, a guardian (or other individual) may add a list of “allowed” and/or “blocked” callers to the database 116, such that the one or more platform servers 102 may identify known and/or unknown callers. By way of another example, the one or more platform servers 102 may identify one or more callers as “fraudsters” and add them to the “blocked” caller list (blacklist). For instance, the caller data 101 may indicate that the owner of the calling phone number is a marketing company, such that the platform 102 may be configured to search via OpenSource Intelligence tools (OSINTs) any additional information regarding their campaigns and determine whether the call is “spam”.

In embodiments, the one or more platform servers 102 include a sentiment analysis module 118. The sentiment analysis module 118 may include one or more sentiment analysis models/algorithms. For example, the sentiment analysis module 118, via the one or more sentiment analysis models/algorithms, may be configured to analyze the sentiment of the call in near real-time. In one instance, the one or more sentiment analysis models may include one or more pre-defined models. In another instance, the one or more sentiment analysis models may include one or more proprietary models.

The one or more pre-defined models may include one or more third party sentiment analysis models. For example, the one or more third party sentiment analysis models may be configured to provide basic sentiment analysis of the data. For instance, the one or more third party sentiment analysis modules may be configured to analyze the message to detect sentiment analysis of positive, negative, neutral, happy, sad, and the like. In this regard, the one or more proprietary models may then be configured to determine domain specific sentiments in the fraud/abuse domain (e.g., threatening, demeaning, coercive, and the like).

It is noted herein that the one or more sentiment analysis models may utilize any artificial intelligence algorithm. For example, the one or more sentiment analysis models may utilize one or more natural language processing (NLP) techniques. For instance, the one or more NLP techniques may be configured to detect one or more fraud/abuse triggers in near real-time (e.g., requests for PII, PHI, SSN, financial information, and the like, threatening or inappropriate language, and the like).

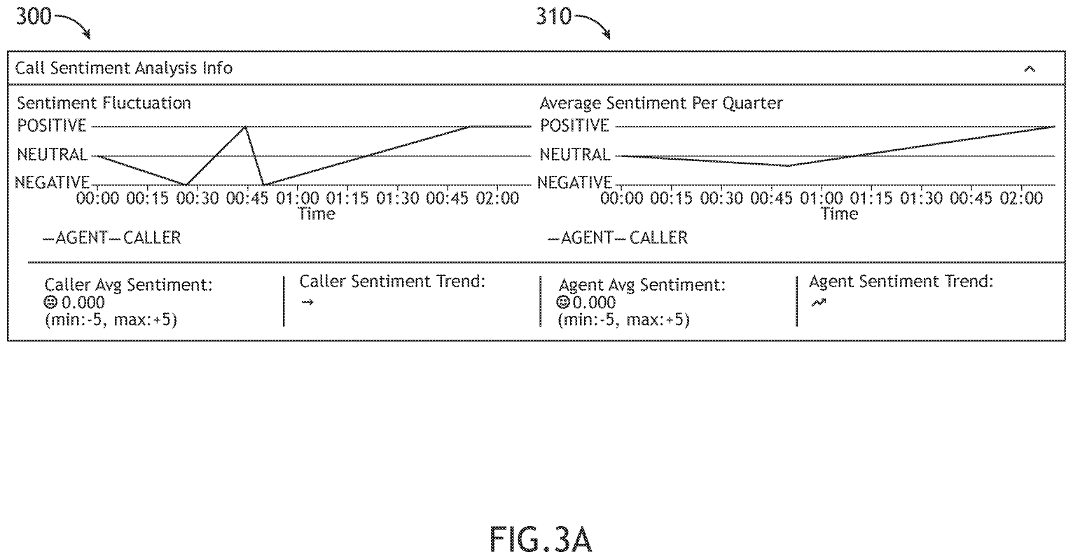

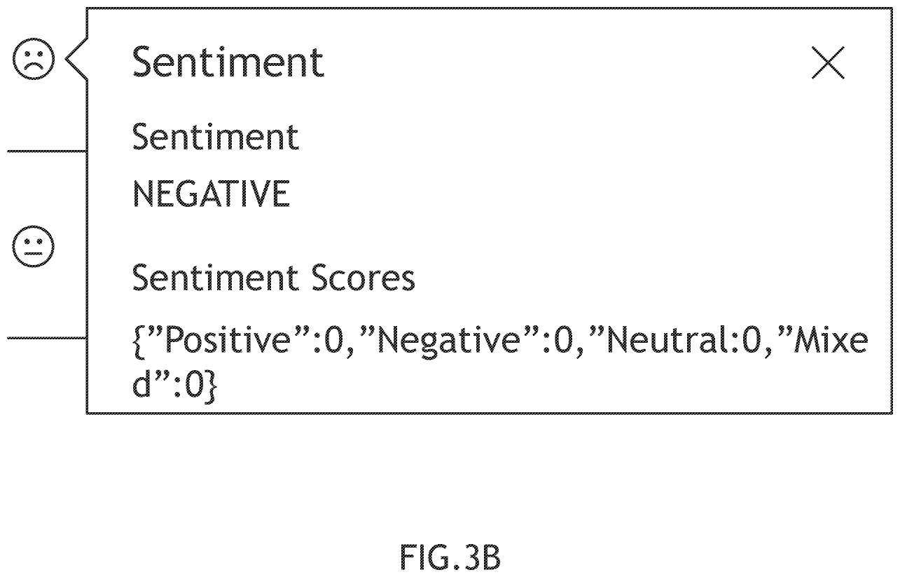

FIGS. 3A-3B illustrate sentiment analysis of a call, in accordance with one or more embodiments of the present disclosure.

The result of the sentiment analysis performed by the one or more sentiment analysis models may be displayed in near real-time during the call. For example, as shown in FIG. 3A, a sentiment fluctuation plot 300 may be displayed during the call (or during a replay of the call). The sentiment fluctuation plot 300 may indicate positive, neutral, and/or negative sentiment fluctuations during the time of the call. For example, the sentiment analysis model may be configured to detect one or more fraud/abuse triggers in near real-time and indicate in the plot 300 when such triggers are detected. The one or more fraud/abuse triggers may include requests for PII, PHI, SSN, financial information, and the like. Further, the one or more fraud/abuse triggers may include threatening or inappropriate language. By way of another example, as shown in FIG. 3A, an average sentiment per quarter plot 310 may be during the call. The average sentiment per quarter plot 310 may indicate an average sentiment per quarter of positive, neutral, and/or negative sentiment fluctuations during the time of the call.

In embodiments, the one or more platform servers 102 includes a risk scoring module 120 configured to determine a risk score using a risk scoring algorithm. For example, the risk scoring algorithm may be configured to determine a risk score 302 associated with a likelihood of fraud/abuse.

For instance, the one or more pre-defined models and/or the one or more proprietary models may utilize an algorithm to quantify the confidence level that the content of the message does exemplify the sentiment indicated. In this regard, in a pre-defined model, common expressions of positive language may reflect a higher score in the expressed “positive” sentiment. These scores typically are set up in the range of 0 to 1 with a “high” score being closer to 1, expressed in a decimal format, such as 0.85. The “higher” the score, the more confidence is expressed by the algorithm that the sentiment is correct. The score reflected can then be compared against thresholds to determine an action or inaction. For instance, a 0.56 confidence score for positive may not be sufficiently high to trigger an action while a 0.85 negative sentiment score could trigger a notification for a person to review.

The confidence score in the fraud or abuse domain is considered the “risk” score so if the threatening or coercive language is detected with a high enough degree of confidence, the risk score may indicate one or more future actions (e.g., trigger a notification to a caregiver, trigger the “circuit breaker” to end the call or end the caller to an AI interviewer, and the like), as discussed further herein.

In embodiments, the one or more platform servers 102 includes a circuit breaker module 122 configured to perform one or more actions based on the determined risk score. For example, based on the determined risk score, the circuit breaker 122 of the platform server 102 may be configured to perform one or more risk threshold tier responses. The platform server 102 may be configured to perform one or more configurable responses/mitigation approaches based upon the severity of the detected risk. In one instance, an automated warning to the caller may be inserted into the live call and the caregiver may be notified thereon. In this regard, potential fraud/abuse may be mitigated through use of the warning (e.g., through generating a visual or auditory alert on the callee and/or guardian's device). In another instance, an automated notification that the call is being recorded is performed and confirm that the caller acquiesces. In this regard, potential fraud/abuse may be mitigated through use of the warning. In another instance, where the risk is elevated, the platform server 102 may be configured to direct the call to the screener module, as previously discussed herein. In another instance, the platform server 102 may be configured to terminate the call (e.g., automatically or in response to a user direction).

The one or more risk thresholds may include one or more predetermined thresholds (or user-defined thresholds) based upon the sentiment indicated. For example, if the sentiment indicated is “negative”, a low confidence score may indicate a “warning”. By way of another example, a higher confidence score of “negative” may be categorized as “elevated risk”. In some embodiments, the one or more risk thresholds may be adjusted over time. As shown in FIG. 3B, the graphical user interface may include one or more icons (or symbols) corresponding to the indicated sentiment. For example, an unhappy face symbol may correspond to a negative sentiment. By way of another example, a happy face symbol may correspond to a positive sentiment. In this regard, as shown in FIG. 2, the respective symbol may be displayed during the call (e.g., next to the transcription data) to indicate the indicated sentiment (e.g., negative, positive, neutral, or the like). Although FIGS. 2 and 3B depict a specific icon, it is noted herein that the sentiment may be displayed to a user via any mechanism. For example, color-coded icons may be used (e.g., red, green, yellow) to indicate a level of sentiment.

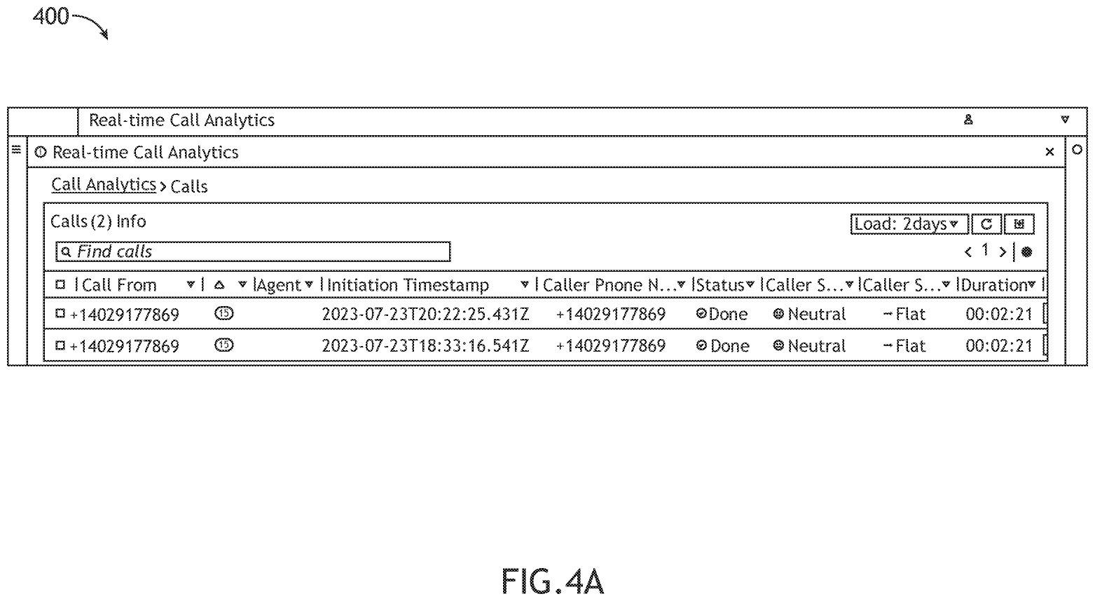

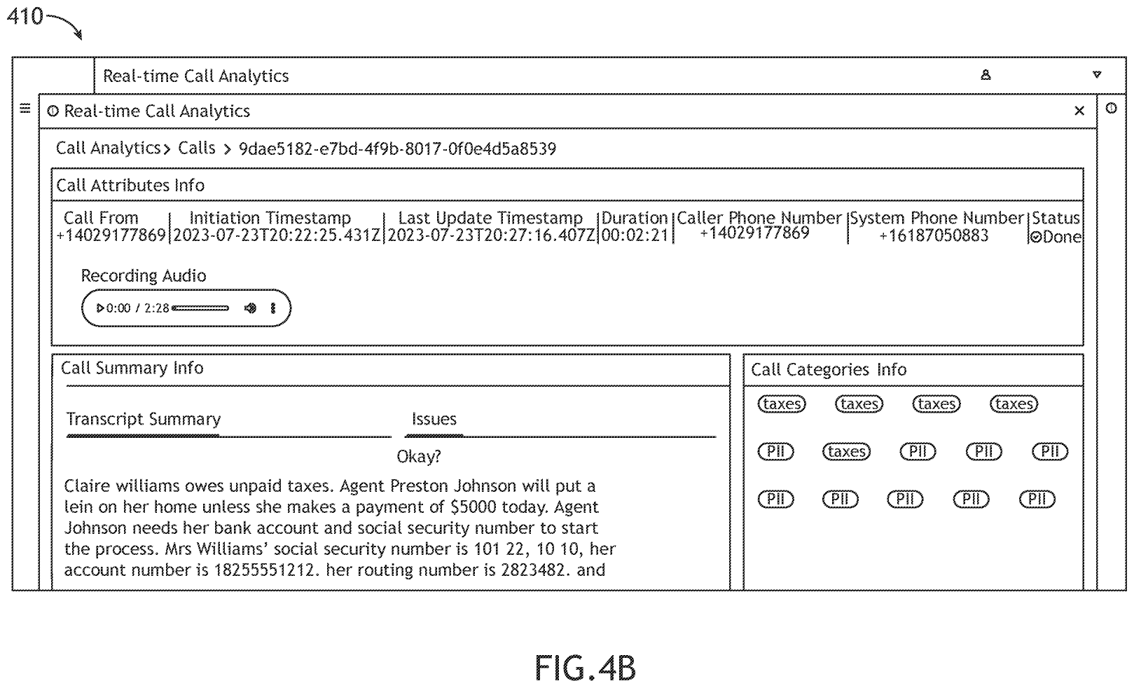

FIG. 4A illustrates call analytics 400, 410, in accordance with one or more embodiments of the present disclosure.

In embodiments, the one or more platform servers 102 include an evidence dossier (or call analytics) stored in memory. For example, as shown in FIGS. 4A-4B, the evidence dossier may include, but is not limited to, call details (e.g., phone number, start/end timestamp, duration, and the like), the audio recording, the transcription data, the call metadata (e.g., call categories/tags), action taken, confidence scores, sentiment, and the like. For instance, as shown in FIG. 4B, a call may be selected from the history (shown in FIG. 4A), where call-specific information may be displayed in the evidence dossier. In this regard, the evidence dossier may be utilized by law enforcement officials or merely for historical purposes.

The evidence dossier may further include the determined risk score. For example, the risk scoring algorithm may be configured to determine a respective risk score based on caller profile data. In this regard, a third-party provider may indicate that the owner of the calling phone number is a marketing company, such that the platform 102 may be configured to search via OpenSource Intelligence tools (OSINTs) any additional information regarding their campaigns and compile a caller dossier along with the determined risk score.

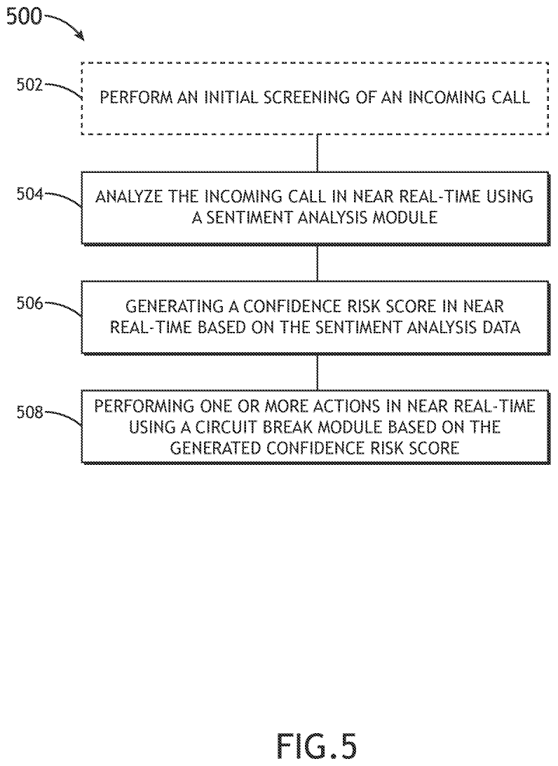

FIG. 5 illustrates a simplified flow diagram of a method 500 for fraud and abuse detection, in accordance with one more embodiments of the present disclosure. It is noted herein that the steps of the method shown in FIG. 5 may be implemented all or in part by the system shown in FIGS. 1A-1B. It is further recognized, however, that the method shown in FIG. 5 is not limited to the system shown in FIGS. 1A-1B in that additional or alternative system-level embodiments may carry out all or part of the steps of method shown in FIG. 5.

In an optional step 502, an initial screening of a call may be performed. For example, the incoming call may be directed to a screening module. For instance, as discussed previously herein, the screening module may be configured to interview the caller to determine the caller's purpose.

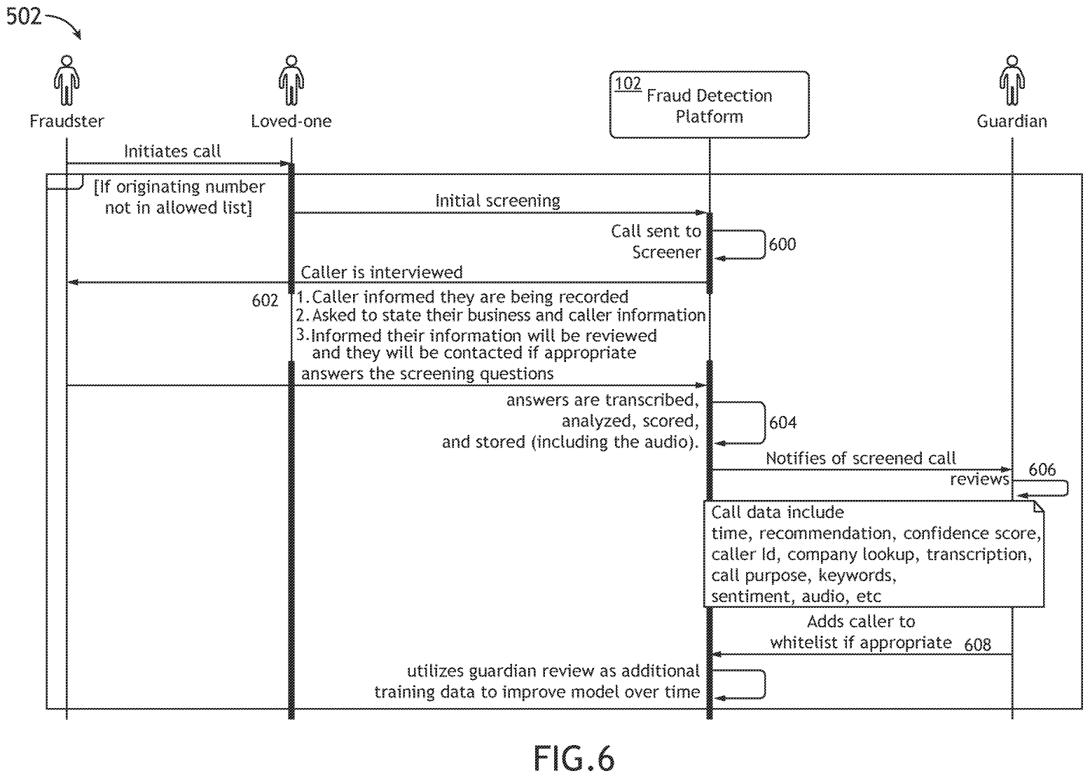

FIG. 6 illustrates a process flow diagram of a step for performing an initial screening 502, in accordance with one or more embodiments of the present disclosure.

In a step 600, if the originating number is not in allowed list of the caller database 116, the call may be sent to a screening module. In a step 602, the screening module may interview the call. For example, the screen module, via an artificial agent or human agent, may be configured to interview the fraudster to determine the purpose of the call. For instance, the screening module may ask the caller a series of screening questions such as, but not limited to, name, position, company, purpose of the call, or the like. For data privacy reasons, the fraudster may be informed that they are being recorded and informed that the information may be stored/reviewed.

In a step 604, the initial screening data may be analyzed and stored in memory. For example, the caller's answers to the questions may be analyzed and stored in memory. In embodiments, the platform server 102, via the transcription module, may be configured to transcribe the interview data and store the transcription and respective audio recording. By way of another example, the platform server 102 may be configured to determine a risk score, via the risk score module, based on the interview data and store the risk score (e.g., confidence score). The analyzed data (e.g., transcription, audio recording, risk score, and the like) may be provided to the guardian for review.

In a step 606, the initial screening data and analyzed data may be provided to the guardian for review. For example, the data may include, but is not limited to, time, confidence score, transcription, purpose of the call, sentiment, audio recording, and the like. As such, the guardian may review such data to determine whether the purpose of the call is legitimate or if the purpose of the call is fraudulent (or potentially fraudulent). It is noted that the received caller data 101 (including any related metadata) may be provided along with or separate from the analyzed data.

In a step 608, if the guardian determines that the call is appropriate, the guardian may add the caller to the “whitelist”.

The guardian review data may be used to train one or more models/algorithms of the platform 102. For example, the review data may be used as feedback loop data to provide data on how accurate the model is in categorizing the data fed to it. For instance, the guardian may indicate whether a risk score was incorrectly calculated. In this regard, the feedback data may indicate that the model failed to identify a threatening or coercive call. Further, the feedback data may indicate that the model incorrectly identified a legitimate call as elevated risk. With the “correction” provided by the guardian, the data provided to train the model is improved so that a new version of the model may be created.

Upon determining that call should not added to the approved caller list, the guardian may take one or more appropriate actions.

In an optional step, the caller may be added to the blacklist. For example, the platform server 102 may store the caller's data (e.g., number, name, etc.) in the blacklist database. In this regard, if the caller were to attempt to contact the loved one again using the same originating number, the platform 102 may prevent the fraudster from

In an optional step, the caller may be connected to the loved-one for a one-time interaction. For example, the guardian may allow a one-time interaction between the loved-one and the caller.

Referring back to FIG. 5, in a step 504, a call between a caller and a callee is analyzed in near real-time for fraud and abuse. For example, a callee may receive a call from a fraudster (or potential fraudster), where the one or more platform servers 102 are configured to analyze the call in near real-time using the one or more modules, as discussed further herein.

In embodiments, the one or more platform servers 102 may be configured to analyze the call in near real-time to detect fraud and abuse. For example, in a step 700, the platform server 102 may be configured to identify/detect one or more fraud/abuse triggers in near real-time based on a call transcription. In one instance, the platform 102 may be configured to detect requests for PII, PHI, SSN, financial information, or the like. In another instance, the platform 102 may be configured to detect inappropriate or threatening language. In a step 702, sentiment analysis may be performed. For example, the one or more sentiment analysis modules 118 may be configured to analyze the call in near real-time to determine a basic sentiment.

In a step 506, a confidence risk score may be calculated.

In a step 508, perform one or more actions using the circuit breaker module based on a determined risk score, the one or more actions including one or more risk threshold tier actions corresponding to a respective risk score.

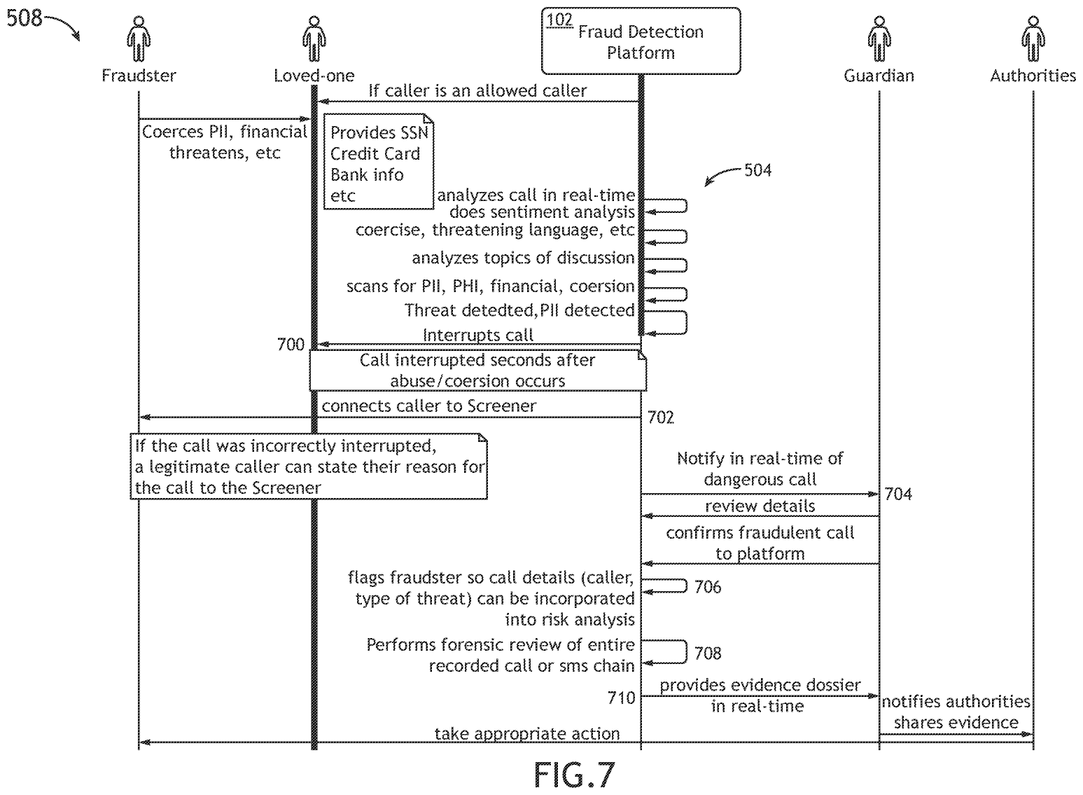

FIG. 7 illustrates a process flow diagram of a step for performing one or more actions 508, in accordance with one or more embodiments of the present disclosure.

Upon identifying one or more fraud/abuse triggers, in an optional step 700, the incoming call is interrupted. For example, the platform 102 may be configured to interrupt the incoming call upon detection of the fraud/abuse. In an optional step 702, the call may be transferred to the screening module, as discussed above with respect to step 204 (FIG. 6).

In a step 508, the data may be provided to the guardian. For example, the platform server 102, via the transcription module, may be configured to transcribe the interview data and store the transcription and respective audio recording. By way of another example, the platform server 102 may be configured to determine a risk score, via the risk score module, based on the interview data and store the risk score (e.g., confidence score). The analyzed data (e.g., transcription, audio recording, risk score, and the like) may be provided to the guardian for review. Further, the received caller data 101 (including any related metadata) may be provided along with or separate from the analyzed data.

In an optional step 704, the guardian reviews the interview data and identifies whether the call is fraudulent.

Upon determining that call is fraudulent, in an optional 706 step, the fraudster is flagged and associated data is stored along with the determined risk score.

In an optional step 708, a forensic review of the audio recording (or SMS chain) is performed and stored in the evidence dossier.

In a step 710, the evidence dossier is stored in memory and provided in near real-time. For example, the evidence dossier may be provided to the guardian (or the caregiver). By way of another example, the evidence dossier may be provided to the authorities (e.g., law enforcement officers, or the like).

In an optional step, the caller may be added to the blacklist. For example, the platform server 102 may store the caller's data (e.g., number, name, etc.) in the blacklist database. In this regard, if the caller were to attempt to contact the loved one again using the same originating number, the platform 102 may prevent the fraudster from

In an optional step, the caller may be connected to the loved-one for a one-time interaction. For example, the guardian may allow a one-time interaction between the loved-one and the caller.

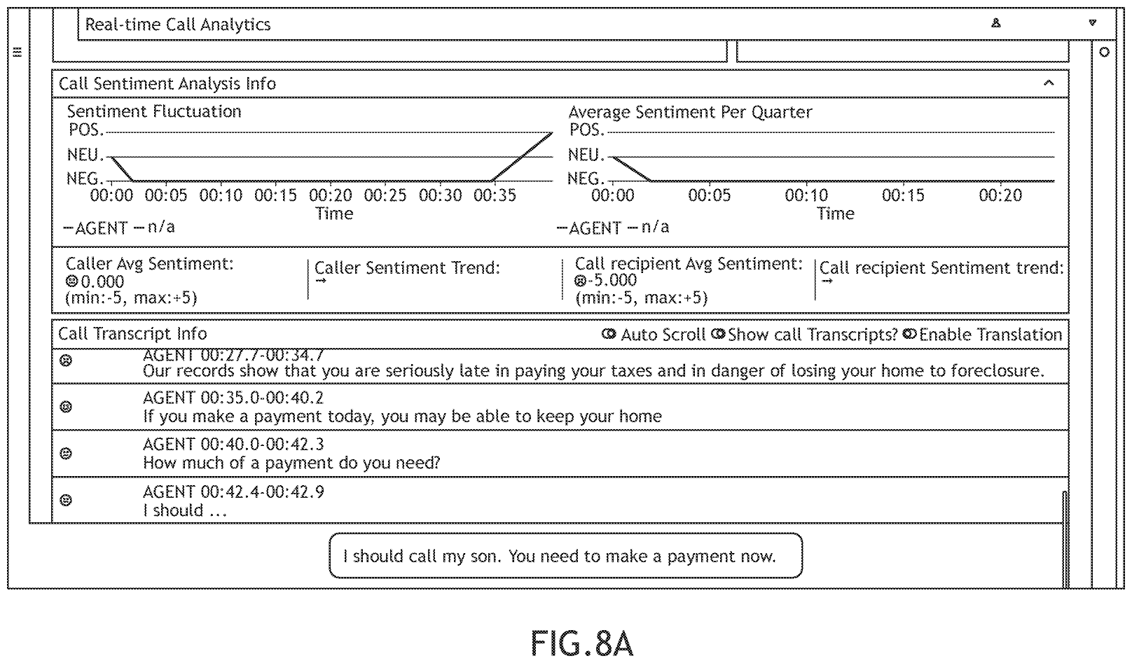

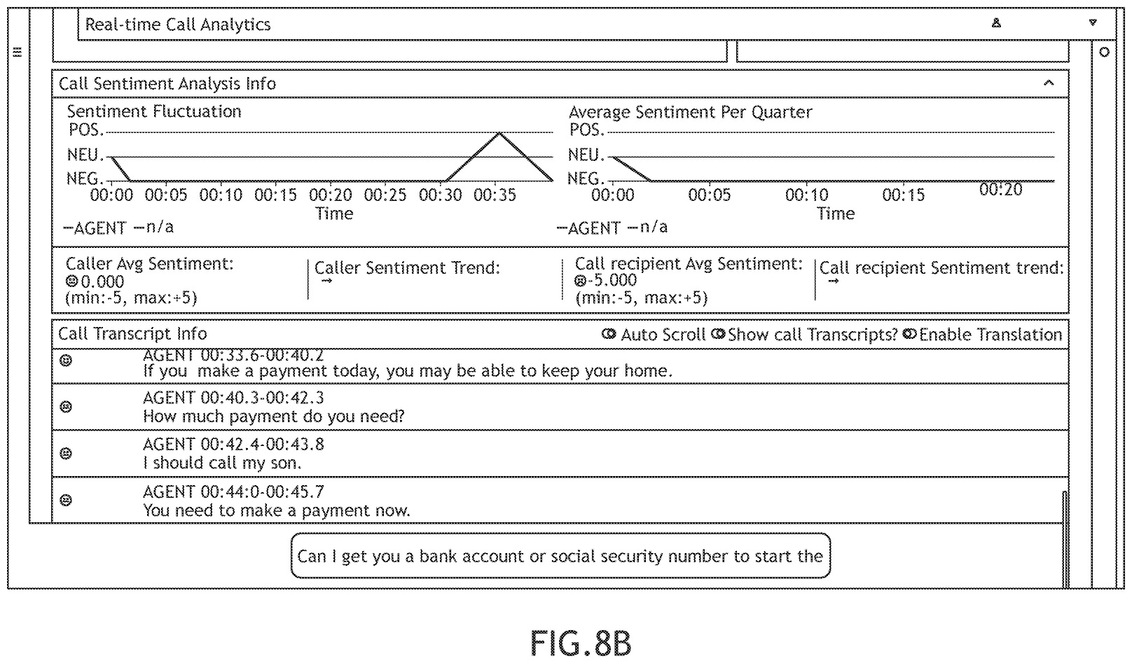

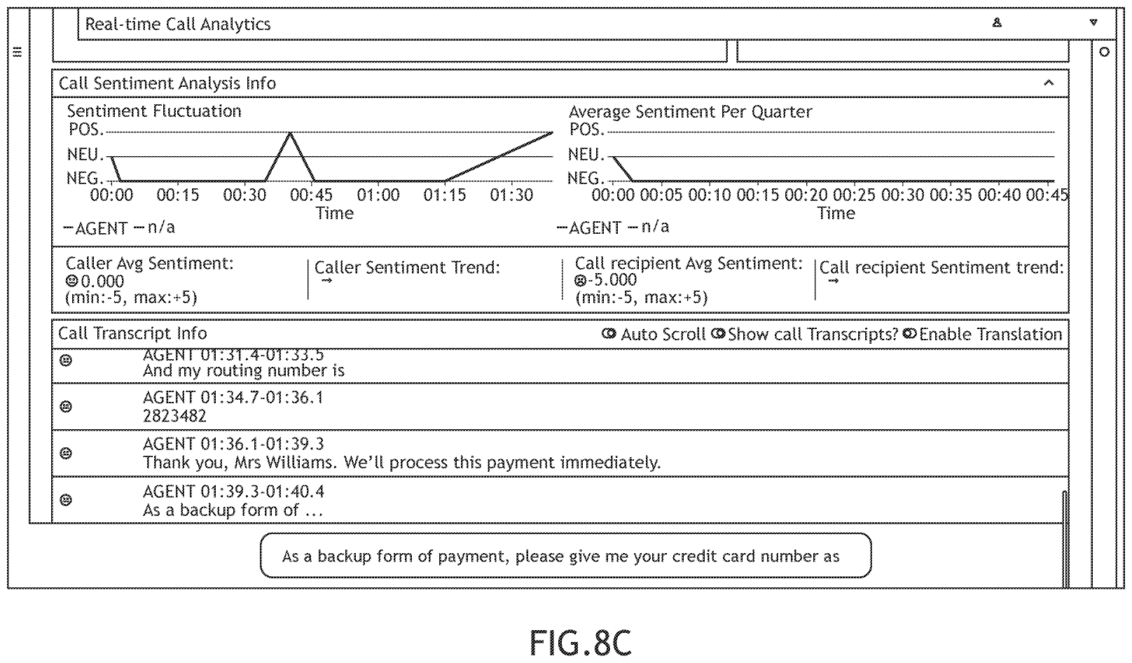

FIGS. 8A-8C illustrate graphical user interfaces depicting a real-time analysis of a call using the fraud and abuse detection system, in accordance with one or more embodiments of the present disclosure.

In a non-limiting example, Claire Williams receives a call from Agent Preston Johnson from the Internal Revenue Service (IRS). Agent Johnson claims that Ms. Williams is late in paying her taxes and in danger of losing her home due to foreclosure. As shown in FIG. 8A, when speaking with Agent Johnson regarding the unpaid taxes and risk of foreclosure, the system 100 analyzes the sentiment of Ms Williams' voice. When Agent Johnson requests payment, the system 100 identifies “positive” sentiment fluctuation in Ms. Williams voice. As shown in FIG. 8B, Agent Johnson asks for Ms. Williams bank account information and social security number. As shown in FIG. 8C, Ms. Williams complies with the request and also provides Agent Johnson with a credit card number for backup payment. The system analyzes the sentiment of Ms. Williams voice at the end of the call and identifies “positive” sentiment fluctuation in Ms. Williams voice. It is contemplated that the real-time call analytics may be stored in the evidence dossier and provided to Ms. Williams' guardian (and even the authorities).

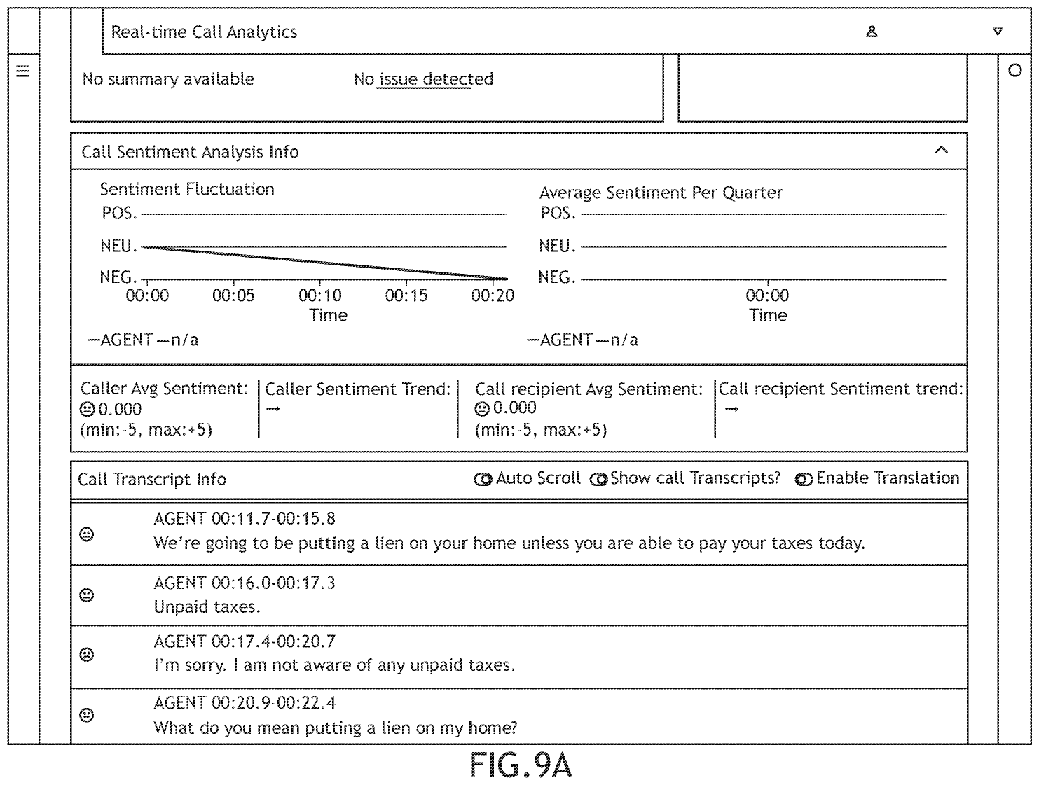

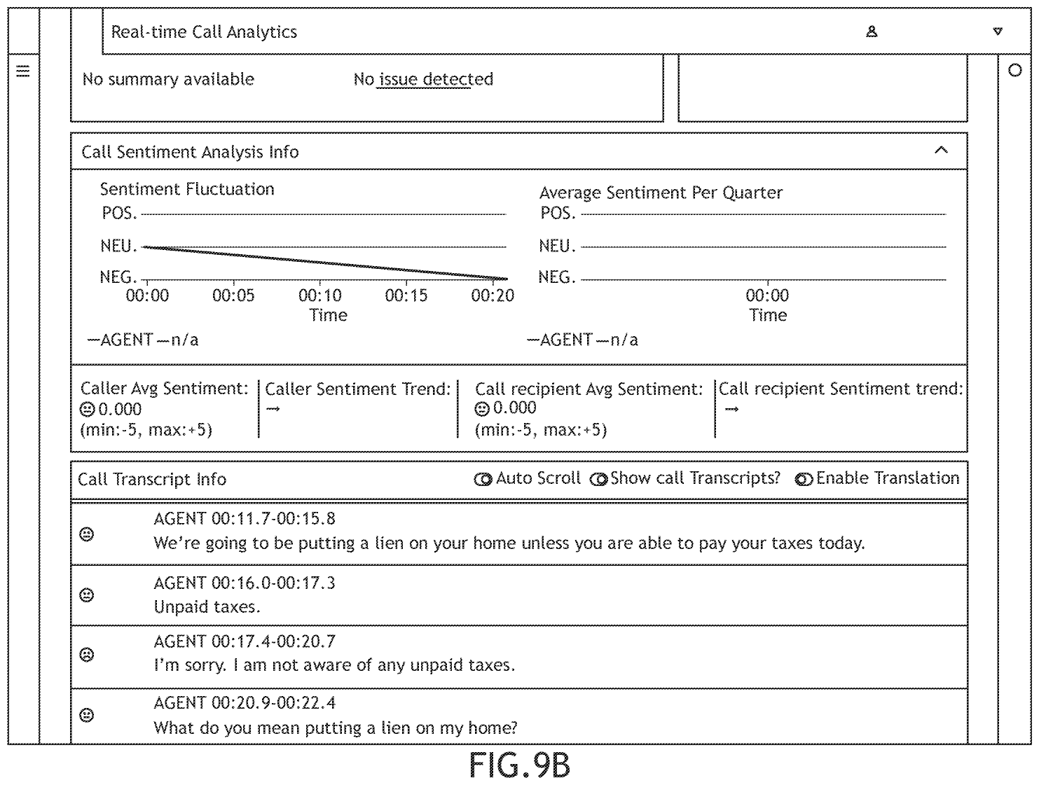

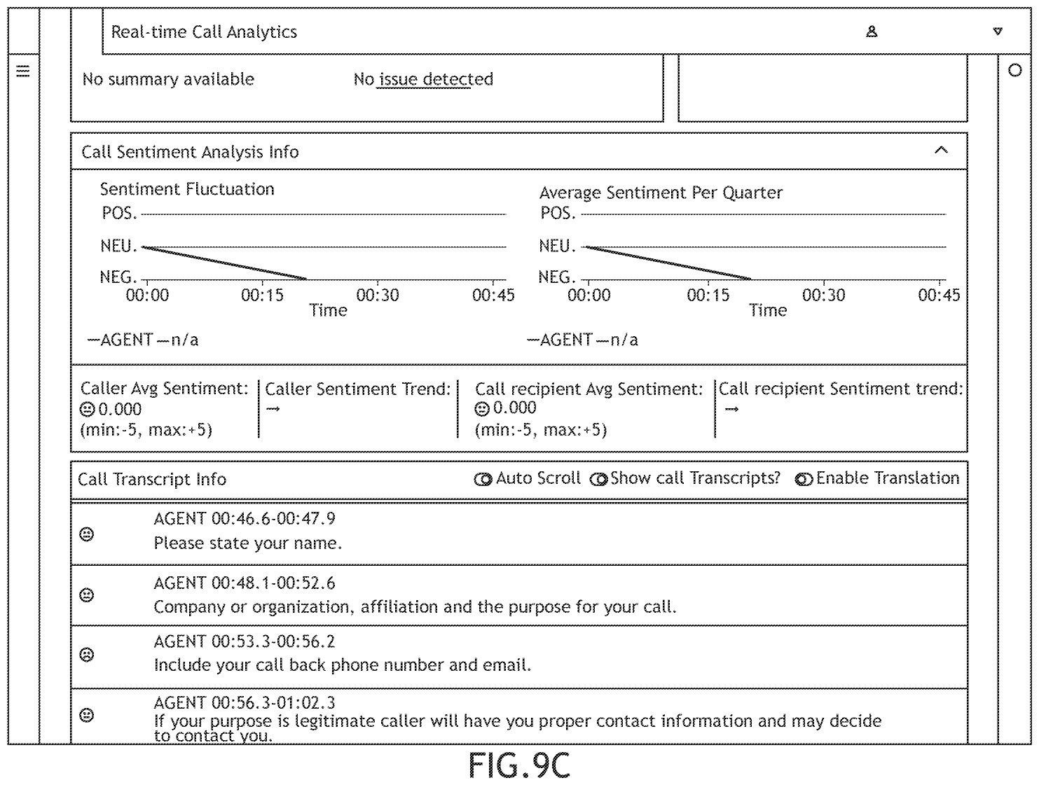

In an additional non-limiting example, Claire Williams receives a call from Agent Preston Johnson from the Internal Revenue Service (IRS). Agent Johnson threats to put a lien on Ms. Williams home unless she pays her taxes today. As shown in FIG. 9A, when speaking with Agent Johnson regarding the unpaid taxes, the system 100 analyzes the sentiment of Ms Williams voice and identifies “negative” sentiment fluctuation in Ms. Williams voice. As shown in FIG. 9B, before Ms. Williams divulges any personal information (e.g., bank account number, SSN, credit card number, or the like), the call is interrupted. For example, as shown in FIG. 9C, Agent Johnson is transferred to a screening agent who asks for additional information (e.g., name, company/affiliation, purpose, phone number/email, and the like). It is contemplated that the real-time call analytics (including the screening information) may be stored in the evidence dossier and provided to Ms. Williams' guardian (and even the authorities).

Referring again to FIG. 1A, in embodiments, the one or more processors 104 may include any one or more processing elements known in the art. In this sense, the one or more processors 104 may include any microprocessor-type device configured to execute software algorithms and/or instructions. For example, the one or more processors 104 may consist of a desktop computer, mainframe computer system, workstation, image computer, parallel processor, or other computer system (e.g., networked computer) configured to execute a program configured to operate the system 100, as described throughout the present disclosure. It should be recognized that the steps described throughout the present disclosure may be carried out by a single computer system or, alternatively, multiple computer systems. Furthermore, it should be recognized that the steps described throughout the present disclosure may be carried out on any one or more of the one or more processors 104. In general, the term “processor” may be broadly defined to encompass any device having one or more processing elements, which execute program instructions from memory 106. Moreover, different subsystems of the system 100 (e.g., user device 110, 112, 114, network 108, server 102) may include processor or logic elements suitable for carrying out at least a portion of the steps described throughout the present disclosure. Therefore, the above description should not be interpreted as a limitation on the present disclosure but merely an illustration.

The memory 106 may include any storage medium known in the art suitable for storing program instructions executable by the associated one or more processors 104. For example, the memory 106 may include a non-transitory memory medium. For instance, the memory 106 may include, but is not limited to, a read-only memory (ROM), a random-access memory (RAM), a magnetic or optical memory device (e.g., disk), a solid-state drive, and the like. It is further noted that memory 106 may be housed in a common controller housing with the one or more processors 104. In an alternative embodiment, the memory 106 may be located remotely with respect to the physical location of the processors 104, user device 110, server 102, and the like. For instance, the one or more processors 104 and/or the server 102 may access a remote memory (e.g., server), accessible through a network (e.g., internet, intranet and the like). The memory 106 may also maintain program instructions for causing the one or more processors 104 to carry out the various steps described through the present disclosure.

In embodiments, the one or more platform servers 102 may receive information from other systems or sub-systems (e.g., a user device 110, 112, 114, one or more additional servers, and/or components of the one or more additional servers) communicatively coupled to the platform server 102 by a transmission medium that may include wireline and/or wireless portions. The server 102 may additionally transmit data or information to one or more systems or sub-systems communicatively coupled to the platform server 102 by a transmission medium that may include wireline and/or wireless portions. In this regard, the transmission medium may serve as a data link between the server 102 and the other systems or sub-systems (e.g., a user device 110, 112, 114, one or more additional servers, and/or components of the one or more additional servers) communicatively coupled to the server 102. Additionally, the server 102 may be configured to send data to external systems via a transmission medium (e.g., network connection).

The communication circuitry of the server 102 may include any network interface circuitry or network interface device suitable for interfacing with network. For example, the communication circuitry may include wireline-based interface devices (e.g., DSL-based interconnection, cable-based interconnection, T9-based interconnection, and the like). In another embodiment, the communication circuitry may include a wireless-based interface device employing GSM, GPRS, CDMA, EV-DO, EDGE, WiMAX, 3G, 4G, 4G LTE, 5G, Wi-Fi protocols, RF, LoRa, and the like.

In embodiment, the one or more user devices 110, 112, 114 may be configured to receive one or more user inputs from a user. For example, the one or more user devices may include a user interface, wherein the user interface includes a display 113 and a user input device 115. The one or more processors 104 may be configured to generate the graphical user interface of the display, wherein the graphical user interface includes the one or more display pages configured to transmit and receive data to and from a user.

The display may be configured to display various selectable buttons, selectable elements, text boxes, and the like, in order to carry out the various steps of the present disclosure. In this regard, the user device may include any user device known in the art for displaying data to a user including, but not limited to, mobile computing devices (e.g., smart phones, tablets, smart watches, and the like), laptop computing devices, desktop computing devices, and the like. By way of another example, the user device may include one or more touchscreen-enabled devices. In embodiments, the display includes a graphical user interface, wherein the graphical user interface includes one or more display pages configured to display and receive data/information to and from a user. The display may include any display device known in the art. For example, the display may include, but is not limited to, a liquid crystal display (LCD), an organic light-emitting diode (OLED) based display, a CRT display, and the like.

The user input device may be coupled with the display by a transmission medium that may include wireline and/or wireless portions. The user input device may include any user input device known in the art. For example, the user input device may include, but is not limited to, a keyboard, a keypad, a touchscreen, a lever, a knob, a scroll wheel, a track ball, a switch, a dial, a sliding bar, a scroll bar, a slide, a handle, a touch pad, a bezel input device or the like. In the case of a touchscreen interface, several touchscreen interfaces may be suitable. For instance, the display may be integrated with a touchscreen interface, such as, but not limited to, a capacitive touchscreen, a resistive touchscreen, a surface acoustic based touchscreen, an infrared based touchscreen, or the like.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

Those having skill in the art will appreciate that there are various vehicles by which processes and/or systems and/or other technologies described herein can be affected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

All of the methods described herein may include storing results of one or more steps of the method embodiments in memory. The results may include any of the results described herein and may be stored in any manner known in the art. The memory may include any memory described herein or any other suitable storage medium known in the art. After the results have been stored, the results can be accessed in the memory and used by any of the method or system embodiments described herein, formatted for display to a user, used by another software module, method, or system, and the like. Furthermore, the results may be stored “permanently,” “semi-permanently,” temporarily,” or for some period of time. For example, the memory may be random access memory (RAM), and the results may not necessarily persist indefinitely in the memory.

It is further contemplated that each of the embodiments of the method described above may include any other step(s) of any other method(s) described herein. In addition, each of the embodiments of the method described above may be performed by any of the systems described herein.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A fraud and abuse detection system, the fraud and abuse detection system comprising:
one or more platform servers communicatively coupled to a caller device, a callee device, and a caregiver device, the one or more platform servers including one or more processors configured to execute a set of program instructions stored in a memory, the one or more platform servers including a sentiment analysis module stored in memory, the one or more platform servers including a circuit breaker module stored in memory, the set of program instructions configured to cause the one or more processors to:
analyze an incoming call in near real-time using the sentiment analysis module, the sentiment analysis module including one or more sentiment analysis models configured to analyze a sentiment of a callee's voice;
generate a confidence risk score in near real-time based on the sentiment analysis of the incoming call, wherein the confidence risk score corresponds to a likelihood of fraud or abuse based on the sentimental analysis data from the sentiment analysis module; and
perform one or more actions using the circuit breaker module based on a determined confidence risk score, wherein the one or more actions include one or more risk threshold tier actions corresponding to a respective confidence risk score.

2. The system of claim 1, wherein the one or more risk threshold tier actions comprise:
disconnect the incoming call in near real-time, wherein the set of program instructions are further configured to cause the one or more processors to generate one or more control signals configured to cause a carrier bridge of a callee user device to disconnect the incoming call in near real-time.

3. The system of claim 1, wherein the one or more risk threshold tier actions comprise:
generating one or more alerts, wherein the set of program instructions are further configured to cause the one or more processors to generate one or more control signals configured to cause one of a callee user device or a guardian user device to generate the one or more alerts in near real-time during the incoming call, wherein the generated one or more alerts include one of a visual alert or an auditory alert.

4. The system of claim 1, wherein the one or more risk threshold tier actions are received from one of a callee or a guardian.

5. The system of claim 1, wherein the set of program instructions are further configured to cause the one or more processors to:
direct the incoming call in near real-time to a screening module; and
perform a screening of the incoming call using the screening module, wherein a screening agent of the screening module is configured to gather screening data from a caller of the incoming call.

6. The system of claim 1, wherein the set of program instructions are further configured to cause the one or more processors to:
provide the screening data along with the sentiment analysis data and the determined confidence risk score to one or more guardian user devices associated with one or more guardians.

7. The system of claim 1, wherein the set of program instructions are further configured to cause the one or more processors to:
store an evidence dossier in the memory, wherein the evidence dossier includes one of call data, a recording of the incoming call, the performed one or more actions of the circuit breaker, the determined confidence risk score, or the analyzed sentiment analysis data.

8. The system of claim 1, wherein the one or more platform servers include a caller database stored in the memory, the caller database including one of an allowed caller database or a blocked caller database.

9. The system of claim 1, wherein the set of program instructions are further configured to cause the one or more processors to:
receive real-time call data via an Application Program Interface, wherein the real-time call data includes a transcription of an audio recording of the incoming call,
wherein the one or more sentiment analysis models of the sentiment analysis module are configured to analyze the transcription of the audio recording of the incoming call in near real-time.

10. A fraud detection system, the fraud detection system comprising:
one or more user devices, wherein the one or more user devices include at least a callee user device; and
one or more platform servers communicatively coupled to the callee user device, the one or more platform servers including one or more processors configured to execute a set of program instructions stored in a memory, the one or more platform servers including a sentiment analysis module stored in memory, the one or more platform servers including a circuit breaker module stored in memory, the set of program instructions configured to cause the one or more processors to:
analyze an incoming call in near real-time using the sentiment analysis module, the sentiment analysis module including one or more sentiment analysis models configured to analyze a sentiment of a callee's voice;
generate a confidence risk score in near real-time based on the sentiment analysis of the incoming call, wherein the confidence risk score corresponds to a likelihood of fraud or abuse; and
perform one or more actions using the circuit breaker module based on a determined confidence risk score, wherein the one or more actions include one or more risk threshold tier actions corresponding to a respective confidence risk score.

11. The system of claim 10, wherein the one or more user devices further comprise:
one or more guardian user devices communicatively coupled to the one or more platform servers.

12. The system of claim 11, wherein the set of program instructions are further configured to cause the one or more processors to:
provide the sentiment analysis data and the determined confidence risk score to one or more guardian user devices associated with one or more guardians.

13. The system of claim 10, wherein the one or more risk threshold tier actions comprise:
disconnect the incoming call in near real-time, wherein the set of program instructions are further configured to cause the one or more processors to generate one or more control signals configured to cause a carrier bridge of a callee user device to disconnect the incoming call in near real-time.

14. The system of claim 10, wherein the one or more risk threshold tier actions comprise:
generating one or more alerts, wherein the set of program instructions are further configured to cause the one or more processors to generate one or more control signals configured to cause one of a callee user device or a guardian user device to generate the one or more alerts in near real-time during the incoming call, wherein the generated one or more alerts include one of a visual alert or an auditory alert.

15. The system of claim 10, wherein the one or more risk threshold tier actions are received from one of a callee or a guardian.

16. The system of claim 10, wherein the set of program instructions are further configured to cause the one or more processors to:
direct the incoming call in near real-time to a screening module; and
perform a screening of the incoming call using the screening module, wherein a screening agent of the screening module is configured to gather screening data from a caller of the incoming call.

17. The system of claim 10, wherein the set of program instructions are further configured to cause the one or more processors to:
store an evidence dossier in the memory, wherein the evidence dossier includes one of call data, a recording of the incoming call, the performed one or more actions of the circuit breaker, the determined confidence risk score, or the analyzed sentiment analysis data.

18. The system of claim 10, wherein the one or more platform servers include a caller database stored in the memory, the caller database including one of an allowed caller database or a blocked caller database.

19. The system of claim 10, wherein the set of program instructions are further configured to cause the one or more processors to:
receive real-time call data via an Application Program Interface, wherein the real-time call data includes a transcription of an audio recording of the incoming call,
wherein the one or more sentiment analysis models of the sentiment analysis module are configured to analyze the transcription of the audio recording of the incoming call in near real-time.

20. A method comprising:
analyzing an incoming call in near real-time using a sentiment analysis module, wherein the sentiment analysis module includes one or more sentiment analysis models configured to analyze a sentiment of a callee's voice;
generating a confidence risk score in near real-time based on the sentiment analysis of the incoming call, wherein the confidence risk score corresponds to a likelihood of fraud or abuse based on the sentimental analysis data from the sentiment analysis module; and
performing one or more actions using a circuit breaker module based on the generated confidence risk score, wherein the one or more actions include one or more risk threshold tier actions corresponding to a respective confidence risk score.
